(19) United States
(12) Patent Application Publication
(10) Pub. No.: US 2017/0225280 A1
(43) Pub. Date: Aug. 10, 2017

(54) METHOD FOR PRODUCING WOODWORKING SPADE BITS

(71) Applicant: Compass Corp., Tainan City (TW)

(72) Inventor: Tzu-Chien Wang, Tainan City (TW)

(21) Appl. No.: 15/040,880

(22) Filed: Feb. 10, 2016

(51) Int. Cl. B23P 15/28; C21D 1/26; C21D 1/06; B27G 15/00; B23K 31/02

(52) U.S. Cl. CPC B23P 15/28; B27G 15/00; B23K 31/02; C21D 1/06; C21D 1/26

(57) ABSTRACT

A method for producing woodworking spade bits includes producing shanks from cylindrical rods. Each shank includes a front connecting portion including a front welding face extending between two front inclined sides and having a first width. Bits are produced from a flat board. Each bit includes a front end having a drilling portion with a second width larger than the first width. Each bit further includes a rear end having a rear connecting portion. The rear connecting portion includes two rear inclined sides extending rearwards towards a longitudinal axis. The rear connecting portion further includes a rear welding face extending between the rear inclined sides and having a width equal to the first width. The front welding face of each shank and the rear welding face of each bit are welded together, forming semi-products of woodworking spade bits which are heat processed, surface treated, and grinded to obtain final products.

### BACKGROUND OF THE INVENTION

The present invention relates to a method for producing woodworking spade bits and, more particularly, to a method for producing woodworking tool spade bits to reduce the inventory.

Wood materials generally have special grains, and woodworking spade bits are generally used to proceed with hole drilling operation of the wood materials. With reference to FIG. 7, a woodworking spade bit 1′ generally includes a shank 11′ and a bit portion 12′ and is generally formed by forging, lathing, cutting, and grinding a cylindrical rod. The shank 11′ is lathed to provide a standardized polygonal shape for coupling with an external tool. The bit portion 12′ is subjected to lathing and grinding and includes a main cutting portion 121′ having two cutting portions 122′ at two sides thereof. A pointed guiding section 123′ protrudes from a center of a front end of the main cutting portion 121′. A side pointed portion 124′ is provided on the front end of each of two sides of the main cutting portion 121′. In the beginning of a drilling operation, the spade bit 1′ is rotated to drill a small hole in wood with the guiding section 123′ of the bit portion 12′. Then, the main cutting portion 121′ rotates into the wood to proceed with the drilling operation.

The diameter of the hole formed by the spade bit 1′ is equal to a width W′ of the main cutting portion 121′. When it is desired to drill holes of different diameters in the wood, a corresponding number of spade bits 1′ of different diameters is required. In manufacture, a plurality of cylindrical rods is subjected to forging and lathing to provide spade bits 1′ having bit portions 121′ with different widths, leading to an increase in the manufacturing costs and inconvenience to inventory.

Furthermore, the shank 1′ and the bit portion 12′ of the spade bit 1′ are made of the same material. The spade bit 1′ is often produced from a low hardness material (such as middle/low carbon steel) to reduce the costs, resulting in a low hardness at the bit portion 12′ which tends to wear after a period of time of use and requires replacement of the whole spade bit 1′. If the whole spade bit 1′ is made from a high hardness material (such as high carbon steel), the costs will be increased significantly, failing to fulfill the economic interest.

U.S. Patent Publication No. 20090269155 discloses a wood flat drill bit and a connecting assembly which are detachably coupled. However, relative axial displacement or loosening is apt to exist between the drill bit and a connecting rod of the connecting assembly after assembly, leading to unstable drilling operation and a large error in the diameter.

### BRIEF SUMMARY OF THE INVENTION

An objective of the present invention is to provide a method for producing woodworking tool spade bits to reduce the inventory.

Another objective of the present invention is to provide a method for producing woodworking tool spade bits to prolong the service life of the woodworking spade bits.

A method for producing woodworking spade bits according to the present invention includes:

producing a plurality of shanks from a plurality of cylindrical rods, with each of the plurality of shanks having a first longitudinal axis and including a front end having a front connecting portion, with the first connecting portion including two front inclined sides extending forwards and away from the first longitudinal axis, with the two front inclined sides having a first angle therebetween, with the front connecting portion further including a front welding face extending between front ends of the two front inclined sides, extending perpendicularly to the first longitudinal axis, and having a first width perpendicular to the first longitudinal axis, with each of the plurality of shanks further including a rear end adapted for coupling with an external tool;

producing a plurality of bits from at least one flat board, with each of the plurality of bits having a second longitudinal axis and including a front end having a drilling portion with a second width perpendicular to the second longitudinal axis and larger than the first width, with each of the plurality of bits further including a rear end having a rear connecting portion, with the rear connecting portion including two rear inclined sides extending rearwards towards the second longitudinal axis, with an angle between the two rear inclined sides being equal to the first angle, with the rear connecting portion further including a rear welding face extending between rear ends of the two rear inclined sides, extending perpendicularly to the second longitudinal axis, and having a width perpendicular to the second longitudinal axis and equal to the first width;

welding the front welding face of each of the plurality of shanks and the rear welding face of one of the plurality of bits together, forming a plurality of semi-products of woodworking spade bits;

heat processing and surface treating the plurality of semi-products of woodworking spade bits; and

grinding the plurality of semi-products of woodworking spade bits to obtain a plurality of products of woodworking spade bits.

Each of the plurality of cylindrical rods can be forged and lathed to form one of the plurality of shanks having a first diameter. A rear end of each of the plurality of shanks is a polygon adapted for coupling with the external tool. A front end of each of the plurality of shanks includes a conical portion having increasing diameters away from the rear end and a cylindrical portion in front of the conical portion and having a diameter larger than the first diameter. A front end of the conical portion and the cylindrical portion of each of the plurality of shanks are pressed flat to expand forwards and then subjected to lathing or grinding to form the front connecting portion.

In an example, the at least one flat board includes a flat board having a strength greater than a strength of each of the plurality of cylindrical rods. The flat board is pressed to form the drilling portion and the rear connecting portion and is then subjected to grinding and lathing to make the rear welding face correspond to the front welding face.

In an example, heat processing and surface treating the plurality of semi-products of woodworking spade bits includes a heat treatment for increasing hardness and toughness. The heat treatment includes annealing after welding the front welding face of each of the plurality of shanks and the rear welding face of one of the plurality of bits together. Surfaces of the plurality of shanks and the plurality of bits are further processed by finer surface treatment including sandblasting or vibrational grinding.

In an example, each of the plurality of semi-products of woodworking spade bits is grinded to form two cutting edges on two sides of the drilling portion and to form a pointed guiding portion on a front end of the drilling portion.

The present invention will become clearer in light of the following detailed description of illustrative embodiments of this invention described in connection with the drawings.

### DESCRIPTION OF THE DRAWINGS

FIG. 1 is a block diagram illustrating a method for producing woodworking spade bits according to the present invention.

FIG. 2 is a diagrammatic view illustrating a step of the method according to the present invention.

FIG. 3 is a diagrammatic view illustrating another step of the method according to the present invention.

FIG. 4 is a diagrammatic view of a shank and a bit produced from the above two steps.

FIG. 5 is a perspective view of a semi-product obtained from a further step of the method according to the present invention.

FIG. 6 is a perspective view of a product obtained from the method according to the present invention.

FIG. 7 is a perspective view of a conventional woodworking spade bit.

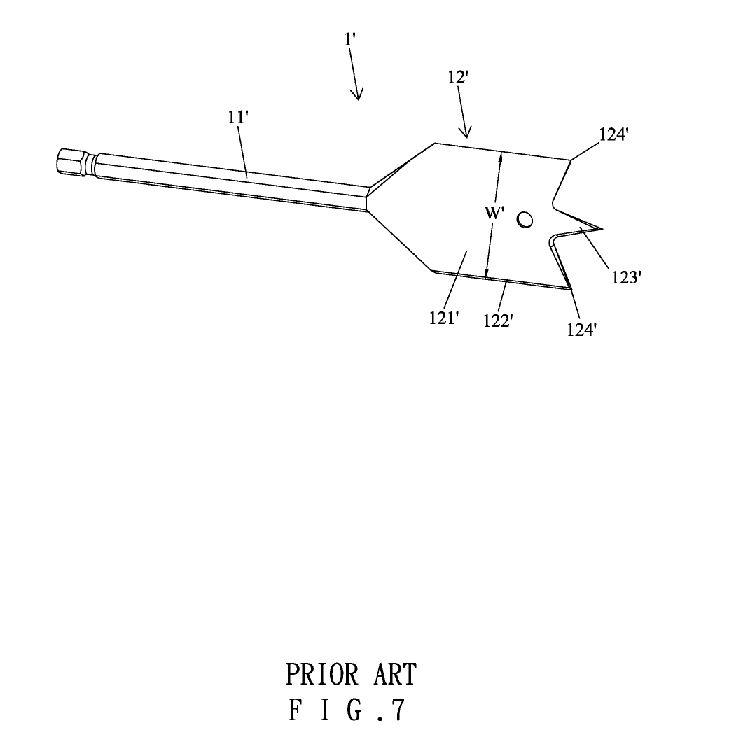

### DETAILED DESCRIPTION OF THE INVENTION

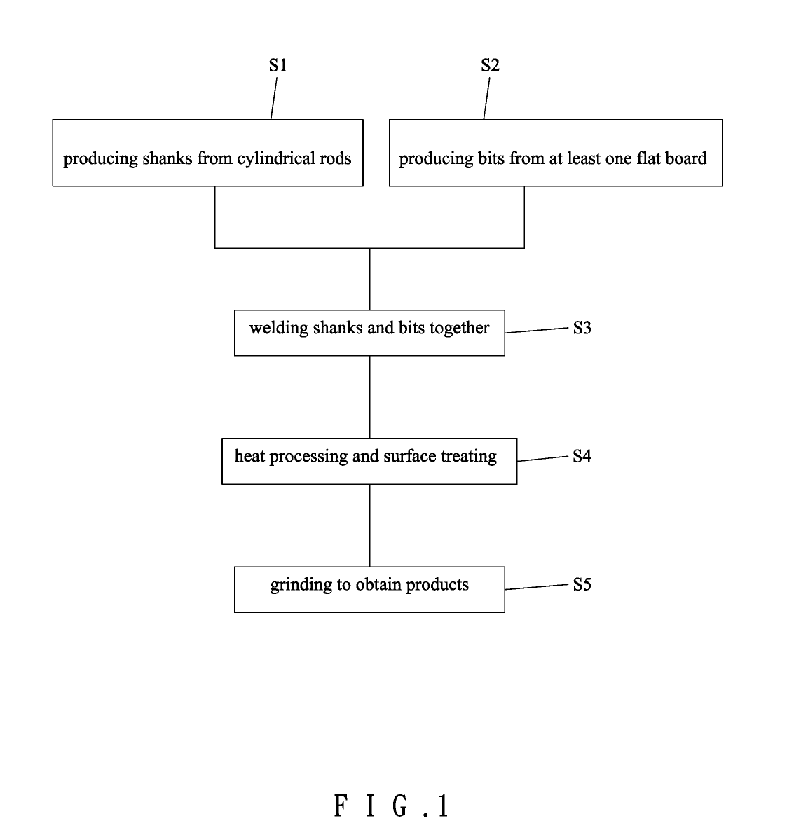

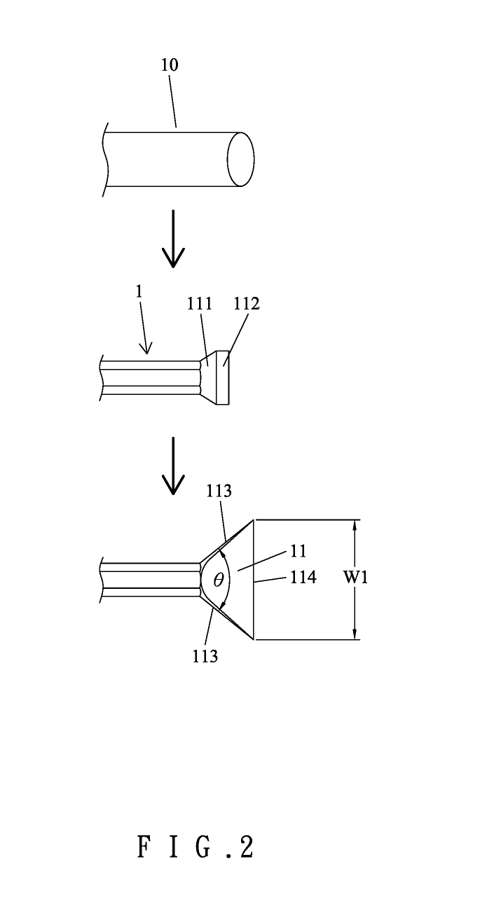

With reference to FIGS. 1-2, a method for producing woodworking spade bits according to the present invention includes a step S1 of producing a plurality of shanks 1 from a plurality of cylindrical rods 10. Each cylindrical rod 10 is forged and lathed to form a shank 1 having a first diameter and a first longitudinal axis. A rear end of each shank 1 is a polygon adapted for coupling with an external tool. A front end of each shank 1 includes a conical portion 111 having increasing diameters away from the rear end and a cylindrical portion 112 in front of the conical portion 111 and having a diameter larger than the first diameter of the shank 1. A front end of the conical portion 111 and the cylindrical portion 112 of each shank 1 are pressed flat to expand forwards and are then subjected to surface treatment (such as lathing or grinding) to form a front connecting portion 11. Provision of the conical portion 111 and the cylindrical portion 112 provides a shape during pressing, with the shape substantially the same as the front connecting portion 11, permitting easy manufacture. The first connecting portion 11 includes two front inclined sides 113 extending forwards and away from the first longitudinal axis. The two front inclined sides 113 have a first angle θ therebetween. The front connecting portion 11 further includes a front welding face 114 extending between front ends of the two front inclined sides 113, extending perpendicularly to the first longitudinal axis, and having a first width W1 perpendicular to the first longitudinal axis. The rear end of each shank 1 has a shape for coupling with the external tool.

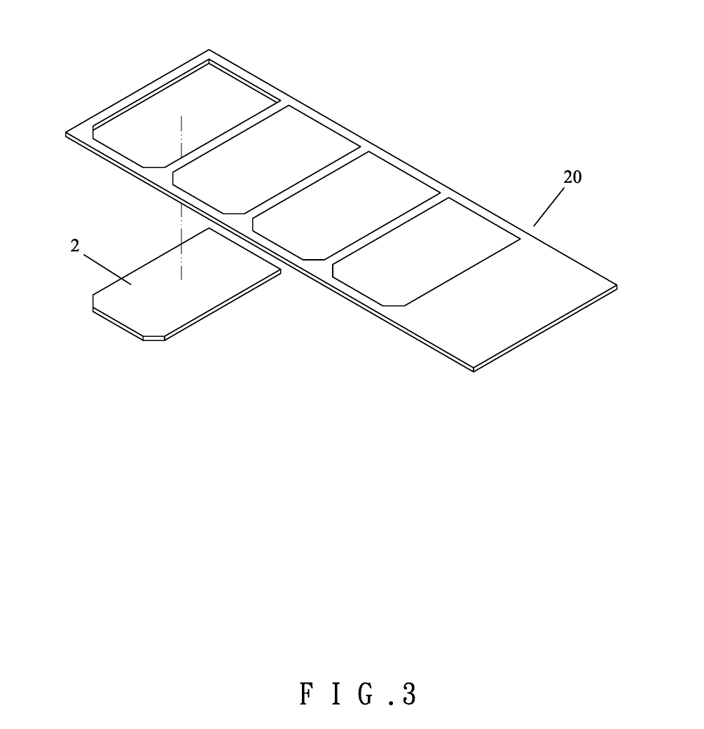

With reference to FIGS. 1-4, the method further includes a step S2 of producing a plurality of bits 2 from at least one flat board 20. In this embodiment, a flat board 20 having a strength greater than a strength of each cylindrical rod 10 is used. The flat board 20 is pressed to form a plurality of bits 2 by one-time pressing. After pressing, each bit 2 has a second longitudinal axis and includes a front end having a drilling portion 21 with a second width W2 perpendicular to the second longitudinal axis and larger than the first width W1. Each bit 2 further includes a rear end having a rear connecting portion 22. The rear connecting portion 22 includes two rear inclined sides 221 extending rearwards towards the second longitudinal axis. An angle θ between the two rear inclined sides 221 is equal to the first angle θ. The rear connecting portion 22 further includes a rear welding face 222 extending between rear ends of the two rear inclined sides 221, extending perpendicularly to the second longitudinal axis, and having a width W1 perpendicular to the second longitudinal axis and equal to the first width W1.

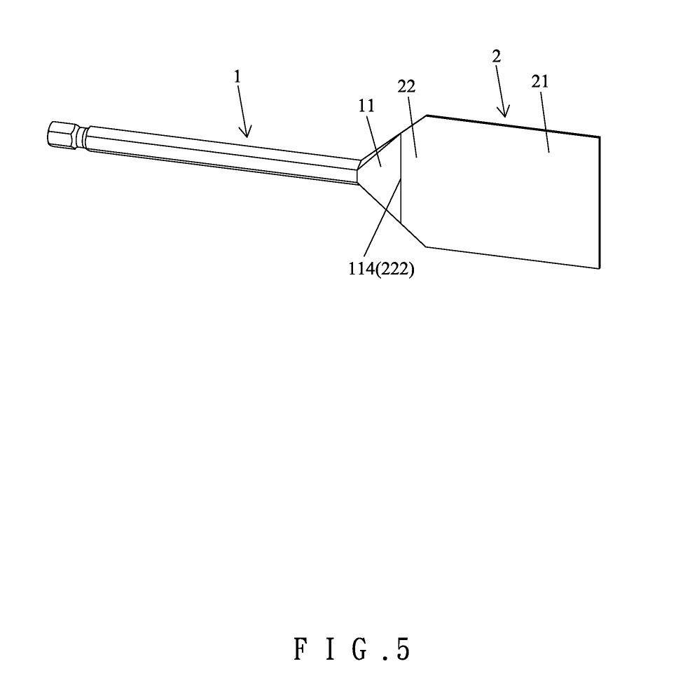

With reference to FIGS. 1-5, the method further includes a step S3 of welding the front welding face 114 of each shank 1 and the rear welding face 222 of one of the bits 2 together, forming a plurality of semi-products of woodworking spade bits.

The method further includes a step S4 of heat processing and surface treating the semi-products of woodworking spade bits. In an embodiment, after the front welding face 114 of each shank 1 and the rear welding face 222 of one of the bits 2 are welded together, a heat treatment including anneal is carried out to increase hardness and toughness.

Furthermore, surfaces of the shanks 1 and the bits 2 are processed by finer surface treatment including sandblasting or vibrational grinding.

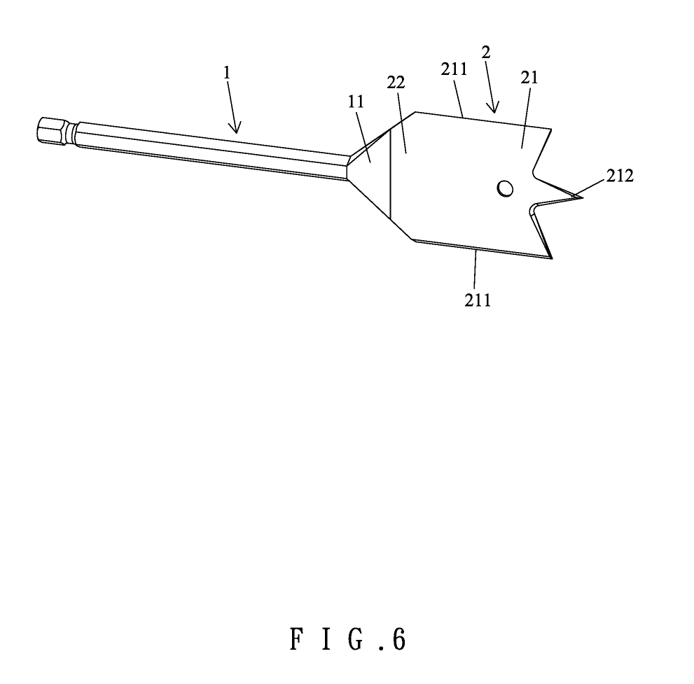

With reference to FIGS. 1 and 6, the method further includes a step S5 of grinding the semi-products of woodworking spade bits to obtain a plurality of products of woodworking spade bits. In an embodiment, the semi-product of each woodworking spade bit is grinded to form two cutting edges 211 on two sides of the drilling portion 21 and to form a pointed guiding portion 212 on a front end of the drilling portion 21.

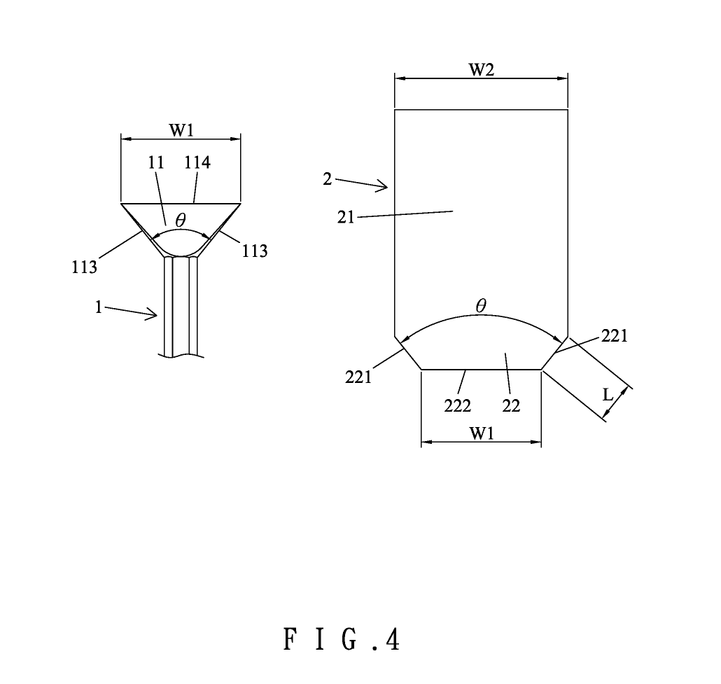

Each shank 1 after step S1 has a fixed shape. The rear coupling portions 22 of the bits 2 after step S2 can have different lengths at the two rear inclined sides 221 (FIG. 4), and the drilling portions 21 can have different corresponding second widths W2. The same shank 1 can couple with different bits 2 of different second widths W2 to reduce the costs of manufacture and inventory of the shanks 1 and to drill holes of different diameters.

The bits 2 are made of a material more rigid than the material for the shanks 1 and are, thus, less likely to wear, prolonging the service life. Furthermore, each bit 2 is welded with an associated shank 1 to avoid relative axial displacement during the drilling operation, providing stable operation.

In view of the foregoing, the method according to the present invention increases the production applicability of the woodworking spade bits and reduces the inventory.

Although specific embodiments have been illustrated and described, numerous modifications and variations are still possible without departing from the scope of the invention. The scope of the invention is limited by the accompanying claims.

1. A method for producing woodworking spade bits, comprising:
producing a plurality of shanks from a plurality of cylindrical rods, with each of the plurality of shanks having a first longitudinal axis and including a front end having a front connecting portion, with the first connecting portion including two front inclined sides extending forwards and away from the first longitudinal axis, with the two front inclined sides having a first angle therebetween, with the front connecting portion further including a front welding face extending between front ends of the two front inclined sides, extending perpendicularly to the first longitudinal axis, and having a first width perpendicular to the first longitudinal axis, with each of the plurality of shanks further including a rear end adapted for coupling with an external tool;
producing a plurality of bits from at least one flat board, with each of the plurality of bits having a second longitudinal axis and including a front end having a drilling portion with a second width perpendicular to the second longitudinal axis and larger than the first width, with each of the plurality of bits further including a rear end having a rear connecting portion, with the rear connecting portion including two rear inclined sides extending rearwards towards the second longitudinal axis, with an angle between the two rear inclined sides being equal to the first angle, with the rear connecting portion further including a rear welding face extending between rear ends of the two rear inclined sides, extending perpendicularly to the second longitudinal axis, and having a width perpendicular to the second longitudinal axis and equal to the first width;
welding the front welding face of each of the plurality of shanks and the rear welding face of one of the plurality of bits together, forming a plurality of semi-products of woodworking spade bits;
heat processing and surface treating the plurality of semi-products of woodworking spade bits; and
grinding the plurality of semi-products of woodworking spade bits to obtain a plurality of products of woodworking spade bits.

2. The method for producing woodworking spade bits as claimed in claim 1, with each of the plurality of cylindrical rods being forged and lathed to form one of the plurality of shanks having a first diameter, with a rear end of each of the plurality of shanks being a polygon adapted for coupling with the external tool, with a front end of each of the plurality of shanks including a conical portion having increasing diameters away from the rear end and a cylindrical portion in front of the conical portion and having a diameter larger than the first diameter, with a front end of the conical portion and the cylindrical portion of each of the plurality of shanks being pressed flat to expand forwards and then subjected to lathing or grinding to form the front connecting portion.

3. The method for producing woodworking spade bits as claimed in claim 1, with the at least one flat board including a flat board having a strength greater than a strength of each of the plurality of cylindrical rods, with the flat board being pressed to form the drilling portion and the rear connecting portion and then subjected to grinding and lathing to make the rear welding face correspond to the front welding face.

4. The method for producing woodworking spade bits as claimed in claim 1, with heat processing and surface treating the plurality of semi-products of woodworking spade bits including a heat treatment for increasing hardness and toughness, with the heat treatment including annealing after welding the front welding face of each of the plurality of shanks and the rear welding face of one of the plurality of bits together, and with surfaces of the plurality of shanks and the plurality of bits being further processed by finer surface treatment including sandblasting or vibrational grinding.

5. The method for producing woodworking spade bits as claimed in claim 1, wherein each of the plurality of semi-products of woodworking spade bits is grinded to form two cutting edges on two sides of the drilling portion and to form a pointed guiding portion on a front end of the drilling portion.
